(19) United States
(12) Patent Application Publication
(10) Pub. No.: US 2012/0172128 A1
(43) Pub. Date: Jul. 5, 2012

(54) Game Controller

(75) Inventor: Jack ATZMON, Englewood, NJ (US)

(73) Assignee: Ergowerx International LLC, Englewood, NJ (US)

(21) Appl. No.: 13/343,427

(22) Filed: Jan. 4, 2012

Related U.S. Application Data
(60) Provisional application No. 61/429,734, filed on Jan. 4, 2011.

(51) Int. Cl. A63F 13/00

(52) U.S. Cl. 463/37

(57) ABSTRACT

A game controller having a central hub and a pair of handles rotateably coupled to the central hub, each handle configured to rotate about an axis, in particular a respective longitudinal axis of the handle.

### RELATED APPLICATIONS

This application claims priority from U.S. Provisional Patent Application Ser. No. 61/429,734 which was filed on Jan. 4, 2011.

### BACKGROUND OF THE INVENTION

1. Field of the Invention

This invention relates to a game controller for a game, and more particularly to a game controller with a rotating handle.

2. Description of the Related Art

A game controller is an input device used to control a video game. A controller is typically connected to a video game console or a personal computer. A game controller can be a keyboard, mouse, gamepad, joystick, paddle, or any other device designed for gaming that can receive input. The game controller is used to govern the movement or actions of an entity in a video or computer game. The type of element controlled depends upon the game, but a typical element controlled would be the actions and movements of a player's character.

Gamepad

A gamepad, is the most common kind of game controller, held with both hands where the thumbs are used to provide input and can have anywhere from a two buttons to a dozen or more buttons, combined with multiple omnidirectional control sticks. Gamepads generally feature a set of action buttons handled with the right thumb and a direction controller handled with the left. These controls typically give the player control of the game element movements in up to three dimensions, with many buttons to perform quick actions. Due to the ease of use and precision of gamepads, they have spread from traditional consoles where they originated to computers as a common input device.

Most modern game controllers are a variation of a standard gamepad. Some common additions to the standard pad include shoulder buttons placed along the edges of the pad, centrally placed buttons labeled start, select, and mode, and an internal motor to provide force feedback.

Gamepads are the primary means of input on nearly all modern video game consoles. Gamepads are also available for personal computers, but few computer games support gamepads, preferring the more conventional keyboards and mice.

Paddle

A paddle is a controller that features a round wheel and one or more fire buttons. The wheel is used to typically control movement of the player or an object along one axis of the video screen.

Joystick

A joystick is a computer peripheral that consists of a handheld stick that can be tilted around either of two axes and (sometimes) twisted around a third.

The joystick typically features a shaft with a sphere-like handle that is grasped, and one or more buttons for in game actions. Generally, the layout has the joystick on the left, and the buttons on the right. There are instances when this is reversed, or the joystick is in the center with button on both sides.

### SUMMARY OF THE INVENTION

A problem associated with game controllers is a cramp where strain is felt on the thumbs and palm. This tends to occur mostly when using particularly small controllers or when any finger or hand is kept in an arched position for an extended period of time. Most controllers are designed to generally conform to the relaxed position of the hands. The pronged design of most controllers is based on the relaxed hand position that reduces soreness and cramping after extended use. However, this static design does not sufficiently reduce the occurrence of repetitive stress injuries (“RSI”) or carpel tunnel syndrome (“CTS”).

Additionally, the standard controller configuration makes It difficult to activate all of the controller features without the user's hands being repositioned, thereby potentially loosing time during gameplay.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is atop view of a game controller according to one embodiment of the invention;

FIG. 2 is a top and front view of a game controller with moveable arms in a rest position;

FIG. 3 is a side view of a game controller with moveable arms in a rest position;

FIG. 4 is a side view of a game controller with moveable arms rotated clockwise; and

FIG. 5 is a side view of a game controller with moveable arms rotated counter-clockwise.

### DETAILED DESCRIPTION OF THE PRESENTLY PREFERRED EMBODIMENTS

The controller is the most common way of interacting with a game. According to one embodiment of the invention, the game controller is ergonomically designed so that it is comfortable and its use avoids injuries such as repetitive stress injuries (“RSI”) or carpel tunnel syndrome (“CTS”).

Disclosed is a game controller that preferably includes (1) one or more ten (10) axis controllers. In one embodiment, the controller changes its relative position and angles relative to the user's hand(s). In one embodiment, the two wings rotate about an axis. This alters the user's finger and wrist angles. It is through this change that use of the controller can reduce the risks of RSI and CTS. Additionally, the ability of the handles to rotate about a handle axis aids in gameplay by, among other things, allowing the user to access various functions in an easier manner.

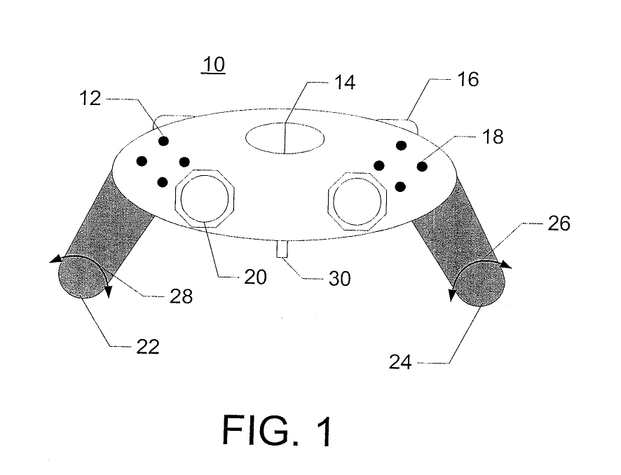

As shown in FIG. 1, a controller 10 includes a center portion and side wings or handles 22, 24. Additionally, as shown, Controller 10 includes two multi-axis controllers 20. Additionally, the controller 10 can include a plurality of control buttons 12, 14, 16, and 18. Other controls buttons or controllers can be used in other embodiments of the controller.

The handle portions 22 and 24 are adapted to be rotatable about longitudinal axes of the handles. Specifically, the handle 22 rotates as shown by arrow 28 and handle 24 rotates as shown by arrow 26. In one embodiment, the handles are biased in a rest position. In another embodiment, there is no bias to the rotation. In one embodiment, the controller 10 has an adjustment element 30 that adjust the bias or tension of the handles 22, 24. In one embodiment, each handle 22, 24 has a respective adjustment element. In one embodiment, the handles 22, 24 are molded with finger grips.

In one embodiment, the controller 10 includes buttons such as 12, 18 and a rocker button such as 14. The controller 10 begins at an initial rest position. From this initial resting period, the handles 22, 24 are adjustable so that they rotate. By rotating the handles 22, 24 the user can vary the user's overall hand position to access the various control buttons faster or easier. Thus, in addition to an ergonomic improvement, controller 10 enhances gameplay.

While the handles have been describes as rotating about a longitudinal axis of the game controller, the handles can rotate about any axis relative to the central hub of the controller 10.

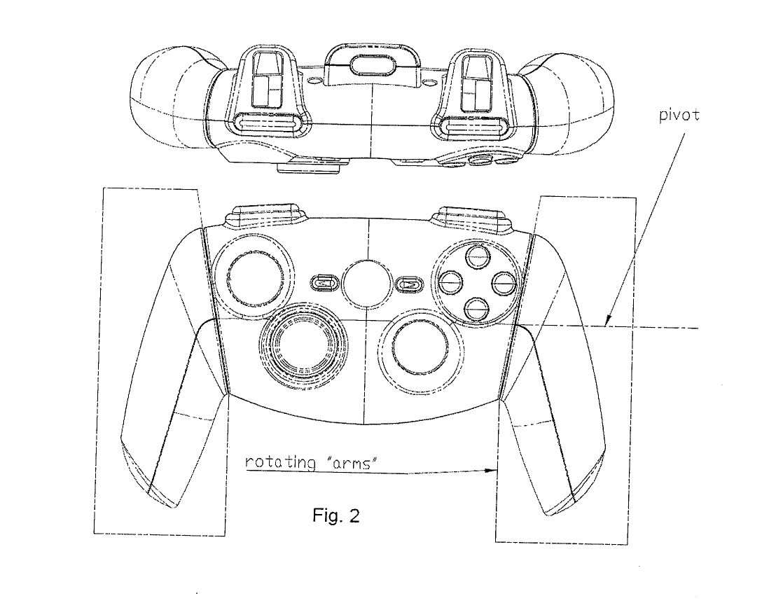

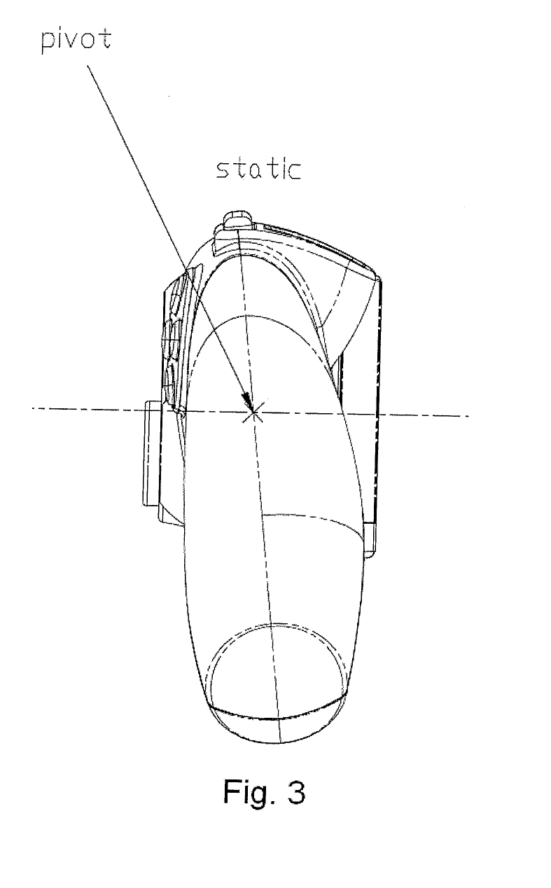

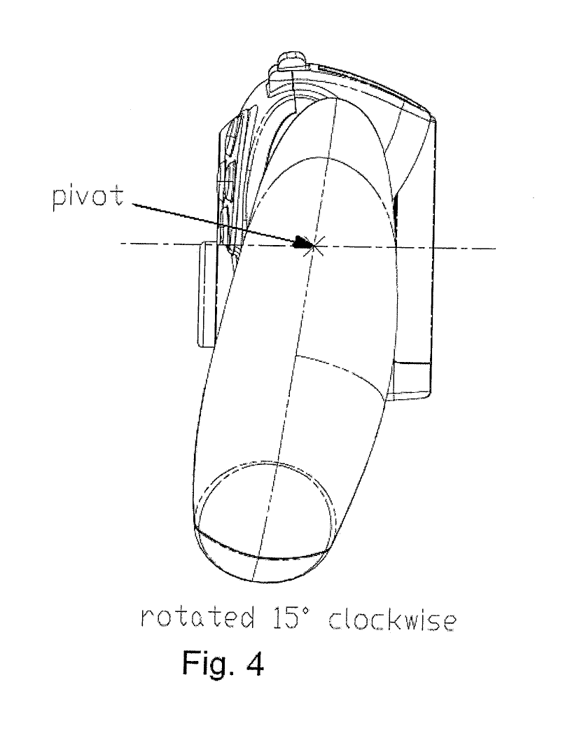

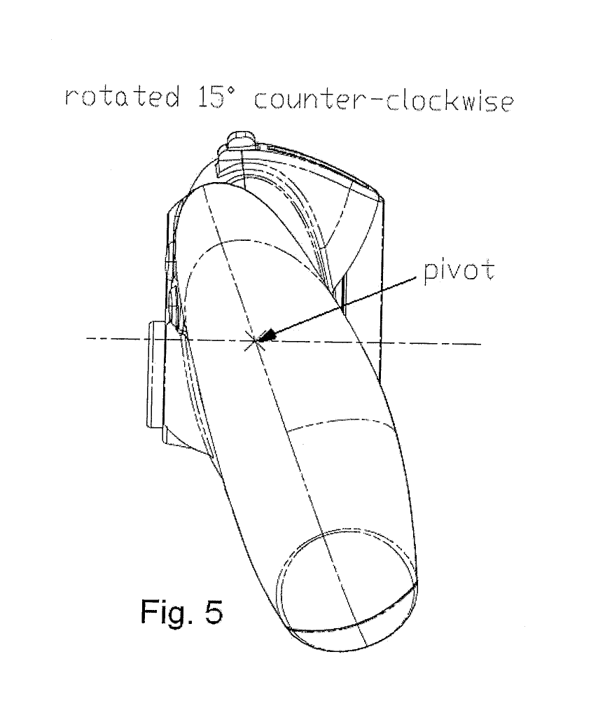

FIGS. 2-5 are a second embodiment of the invention. As shown, respective handles rotate about a respective axis that is offset from a longitudinal axis of the handle. As shown in FIGS. 4 and 5, the handles move in a lever-like fashion, pivoting about 15° from a rest position in both a clockwise and counterclockwise direction. It should be noted that the mating line between the central hub and the handles substantially determines the lever action of the handle. In a preferred embodiment, the handle has a static rest position in the middle of its travel range.

In one embodiment, the handle is coupled to the central hub by a ball and socket joint. Preferably, this joint allows the handle to be capable of motion around an indefinite number of axes, which have one common center. It enables the handle to move in a 360° angle. Alternatively, stops can be provided to limit the range of motion of the joint.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A game controller comprising:
a central hub having a first surface, a second surface opposite the first surface, and a plane arranged between the first and second surfaces; and
a pair of handles rotateably coupled to the central hub, each handle configured to rotate about a single respective axis with respect to the plane of the central hub.

2. The game controller according to claim 1, wherein each respective axis of rotation is a respective longitudinal axis of the handle.

3. The game controller according to claim 2, wherein each respective axis of rotation is complementarily arranged with respect to a longitudinal axis of the central hub.

4. The game controller according to claim 1, wherein the respective axis of rotation of the handle is offset from a longitudinal axis of the handle.

5. The game controller according to claim 4, wherein each respective axis of rotation is arranged along a same line.

6. The game controller according to claim 5, wherein each respective axis of rotation is arranged at the plane of the central hub.

7. The game controller according to claim 6, wherein each handle is configured to rotate at least about 15° above and below a median position.

8. The game controller according to claim 4, further comprising at least one of a button and a multi-axis controller arranged on the central hub.

9. The game controller according to claim 8, wherein each of the handles is free of control elements.

10. The game controller according to claim 4, wherein each of the handles is biased to return to a rest position.

11. The game controller according to claim 7, wherein each of the handles is biased to return to a rest position.

12. The game controller according to claim 11, the rest position is arranged substantially at the median position.

13. A method of using a game controller having a central hub having a first surface, a second surface opposite the first surface, a plane arranged between the first and second surfaces, and at least one of a button and a multi axis controller arranged on the central hub; and a pair of handles rotateably coupled to the central hub, each handle configured to rotate about a single respective axis with respect to the plane of the central hub, the method comprising:
rotating one of the handles to shorten at least one of a first distance and a first access time to the at least one of a button and a multi axis controller; and
rotating the other of the handles to shorten at least one of a second distance and a second access time to the at least one of a button and a multi axis controller .
